(19) United States
(12) Patent Application Publication
(10) Pub. No.: US 2015/0016590 A1
(43) Pub. Date: Jan. 15, 2015

(54) Soft X-Ray Curtain Tube

(71) Applicant: Moxtek, Inc., Orem, UT (US)

(72) Inventors: Todd S. Parker, Kaysville, UT (US); Sanjay Kamtekar, Highland, UT (US); William Hansen, Manteca, CA (US)

(73) Assignee: Moxtek, Inc., Orem, UT (US)

(21) Appl. No.: 14/266,321

(22) Filed: Apr. 30, 2014

Related U.S. Application Data
(60) Provisional application No. 61/833,281, filed on Jun. 10, 2013.

(51) Int. Cl. H01J 35/06; H01J 35/08; G21K 5/04; H01J 35/18

(52) U.S. Cl. CPC H01J 35/06; H01J 35/18; H01J 35/08; G21K 5/04
USPC 378/64; 378/136

(57) ABSTRACT

An elongated x-ray tube that can emit a linear curtain of x-rays along its length. Methods of using an elongated curtain of x-rays.

### CLAIM OF PRIORITY

This claims priority to U.S. Provisional Patent Application No. 61/833,281, filed on Jun. 10, 2013, which is hereby incorporated herein by reference in its entirety.

### FIELD OF THE INVENTION

The present application is related generally to x-ray sources.

### BACKGROUND

Some x-ray applications can be better served by a dispersed and elongated emission of x-rays. The elongated emission can have a length ranging from centimeters to meters. To accomplish a dispersed and elongated emission of x-rays, multiple, individual x-ray sources can be arranged in a linear array. Providing multiple x-ray sources can be expensive and complicated. In order to reduce cost and complexity, it can be beneficial to reduce a total number of x-ray sources used. See for example U.S. Pat. No. 7,346,147 and U.S. Patent Publication Number U.S. 2013/0230147.

### SUMMARY

It has been recognized that it would be advantageous to provide a dispersive, linear emission of x-rays from an x-ray source. It has been recognized that it would be advantageous to provide such dispersive, linear emission in a cost effective manner.

The present invention is directed to an x-ray tube that satisfies these needs. The x-ray tube comprises an elongated, tubular, evacuated enclosure including an electrically conductive anode. An elongated, linear filament can be disposed in the enclosure and can extend along a longitudinal axis of the enclosure and can be configured to emit electrons. The filament can be electrically insulated from the anode. There can be an elongated annular gap between the filament and the anode. The gap can be evacuated within the enclosure. A target material can be associated with the anode, the window, or both, and can be configured to emit x-rays in response to impinging electrons from the filament. A solid x-ray window can be formed in the enclosure and can be configured to substantially allow x-rays to pass therethrough.

The present invention is also directed to methods of utilizing a linear or curtain-like emission of x-rays. The methods comprise (1) providing an elongated x-ray tube capable of emitting x-rays along substantially an entire length of the tube and (2) emitting a substantially uniform linear curtain of x-rays substantially along the length of the tube while passing a material through the x-rays. A third step in the method can comprise one of the following, depending on what the method is used to accomplish: (3a) neutralizing an electrical charge in or on the material by use of the x-rays; (3b) killing microorganisms with the x-rays; (3c) catalyzing a chemical reaction in the material with the x-rays; or (3d) using the x-rays to cause cross-linking of monomers in the material to form a polymer, or breaking cross-links of a polymer in the material to form monomers.

### BRIEF DESCRIPTION OF THE DRAWINGS

FIG. 1 is a schematic perspective-view of an x-ray tube 10 comprising an enclosure 15 including an anode 12 and at least one window 13, and a filament 11 extending along a longitudinal axis 16 of the enclosure 15, in accordance with an embodiment of the present invention;

FIG. 2 is a schematic, longitudinal, cross-sectional side-view of the x-ray tube 10 of FIG. 1 taken along line 2-2 in FIG. 1, in accordance with an embodiment of the present invention; FIG. 3 is a schematic, transverse, cross-sectional side-view of the x-ray tube 10 of FIG. 1 taken along line 3-3 in FIG. 1, in accordance with an embodiment of the present invention;

FIG. 4 is a schematic perspective-view of a an x-ray tube 40, in accordance with an embodiment of the present invention;

FIG. 5 is a schematic perspective-view of an x-ray source 50 including an x-ray tube 50 and a power supply 52, in accordance with an embodiment of the present invention;

FIG. 6 is a schematic, longitudinal, cross-sectional side-view of an x-ray tube 60, similar to x-ray tube 10 shown in FIGS. 1-3, except that on x-ray tube 60 both ends 11a and 11b of the filament 11 are at one end 15a of the enclosure 15 and the filament 11 extends in one direction 61 along a length L of the enclosure, then bends back in an opposite direction 62, in accordance with an embodiment of the present invention;

FIG. 7 is a schematic, longitudinal, cross-sectional, side-view of an x-ray tube 70 with an electrically-conductive, elongated focusing-structure 71 extending in parallel with the filament 11 from one end 15a of the enclosure 15 to an opposite end 15b of the enclosure 15, in accordance with an embodiment of the present invention;

FIG. 8 is a schematic, transverse, cross-sectional side-view of an x-ray tube 80 with a V-shaped focusing-structure 71a, in accordance with an embodiment of the present invention;

FIG. 9 is a schematic, transverse, cross-sectional side-view of an x-ray tube 90 with two focusing-wires as the focusing-structure 71b, in accordance with an embodiment of the present invention; and

FIG. 10 is a schematic perspective view of an x-ray tube 103 providing x-rays 51 for radiation treatment of a material 102, in accordance with methods of the present invention.

### DEFINITIONS

As used herein, diameter D of the enclosure 15 means an internal diameter.
As used herein, “evacuated” means a substantial vacuum, such as is typically used for x-ray tubes.
As used herein, length L of the enclosure 15 means an internal length inside the enclosure 15.
As used herein, “soft x-rays” means x-rays having a wavelength between 0.08 nanometers and 10 nanometers or an energy of less than 15.5 keV.

### DETAILED DESCRIPTION

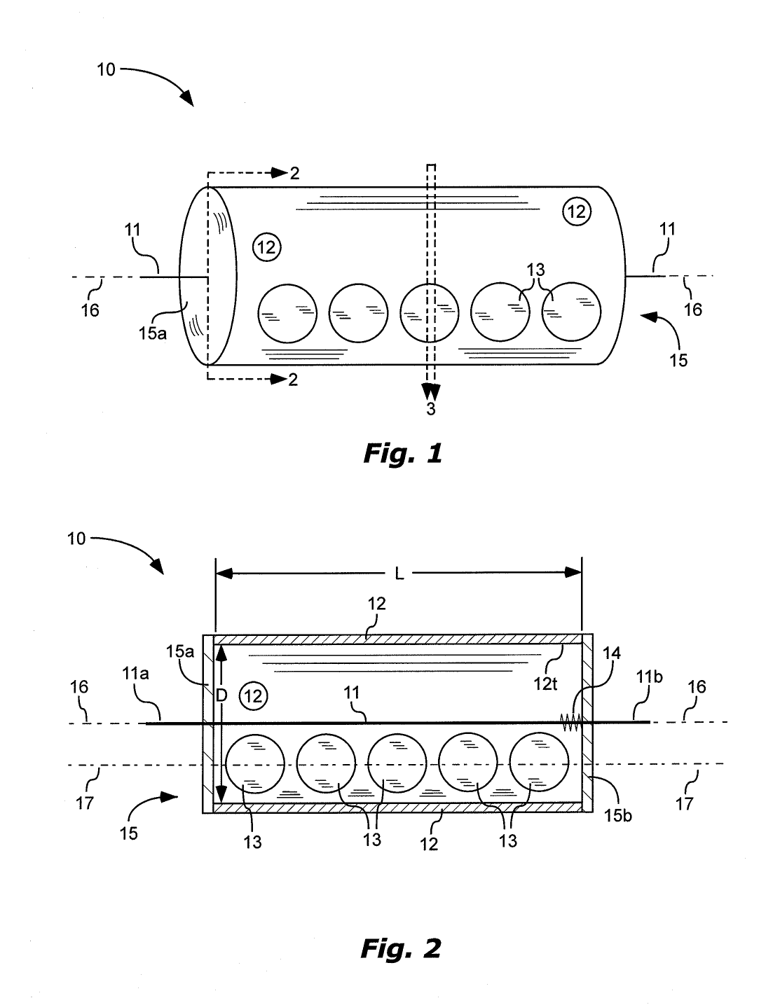

As illustrated in FIGS. 1-9, x-ray tubes 10, 40, 50, 60, 70, 80, and 90 are shown comprising an elongated, tubular, evacuated enclosure 15 including an electrically conductive annular anode 12. An elongated, linear filament 11 can be disposed in the enclosure 15 and can extend along a longitudinal axis 16 of the enclosure 15. The filament 11 can be configured to emit electrons towards the anode 12. The filament 11 can be electrically insulated from the anode 12. The filament 11 can be a wire. The filament 11 can comprise tungsten. There can be an elongated annular gap 18 between the filament 11 and the anode 12.

At least one solid x-ray window 13 can be formed in the enclosure 15. The window(s) can be configured to substantially allow x-rays 51 to pass therethrough due to material of construction and small thickness Th_{w}. The window 13 can be made from materials that have low density and/or low atomic number Z, in order to minimize attenuation of x-rays 51. Examples of window 13 materials include aluminum (Z=13), beryllium (Z=4), boron (Z=5), hydrogen (Z=1), nitrogen (Z=7), and silicon (Z=14). A polymer can be used as a window material, such as polyimide for example. The polymer can be metallized. The window 13 can consist only of materials having an atomic number less than 17.

A target material 12t can be disposed on an inner surface of the anode 12, an inner surface of the window 13, or both. “Inner surface” can mean the surface facing the filament 11 and the evacuated inward part or gap 18 of the enclosure 15. Some, or substantially all, of the inner surface of the anode 12 and/or window 13 can be covered with target material 12t. The target material 12t can be configured to emit x-rays 51 in response to impinging electrons from the filament 11. For example, the target material can be a thin film or sheet of tungsten, tantalum, gold, or other dense and preferably high atomic number metal. The target material 12t can comprise at least one material having an atomic number Z greater than 46 in one aspect or greater than 70 in another aspect. The target material can be a thin sheet of metal (e.g. tungsten, tantalum, or steel plated with gold) rolled and inserted into the x-ray tube. Tension of the rolled sheet can hold the target material 12t against an inside surface of the anode 12.

The enclosure 15 can include a tubular shape. The enclosure 15 can comprise the anode 12, two opposite ends 15a-b, and window(s) 13. The anode 12 can include an annular shape. The filament 11 can extend along the longitudinal axis 16 from one end 15a of the enclosure 15 to an opposite end 15b. The filament can be attached or secured to both ends 15a-b of the enclosure 15. Each end 11a-b of the filament 11 can be configured to be connected to a power supply 52. The anode 12 can be electrically conductive. Ends 15a-b of the enclosure 15 can be electrically insulative in order to isolate the filament 11 from the anode 12.

The x-ray tubes 10, 40, 50, 60, 70, 80, and 90 described herein can be useful for providing a dispersed linear emission or curtain of x-rays 51. Various uses, which can benefit from such a linear curtain of x-rays 51, will be described in more detail below. Various applications require various lengths L of x-ray tubes. For example, the enclosure 15 and the filament 11 can have a length L of greater than 0.05 m in one aspect, greater than 0.1 m in another aspect, greater than 0.2 m in another aspect, greater than 0.4 m in another aspect, greater than 0.8 m in another aspect, greater than 1.5 m in another aspect, or greater than 2.0 m in another aspect. The x-ray tube can provide x-ray flux 51 substantially along this entire length L.

Providing x-ray flux 51 along this length L does not necessarily mean that x-rays are emitted along this entire length. The length L may have individual, separated windows 13 with x-rays primarily emerging from these windows 13. Because the x-rays 51 expand out in multiple directions, however, the x-ray tube can provide a substantially uniform linear curtain of x-rays along the length L of the x-ray tube.

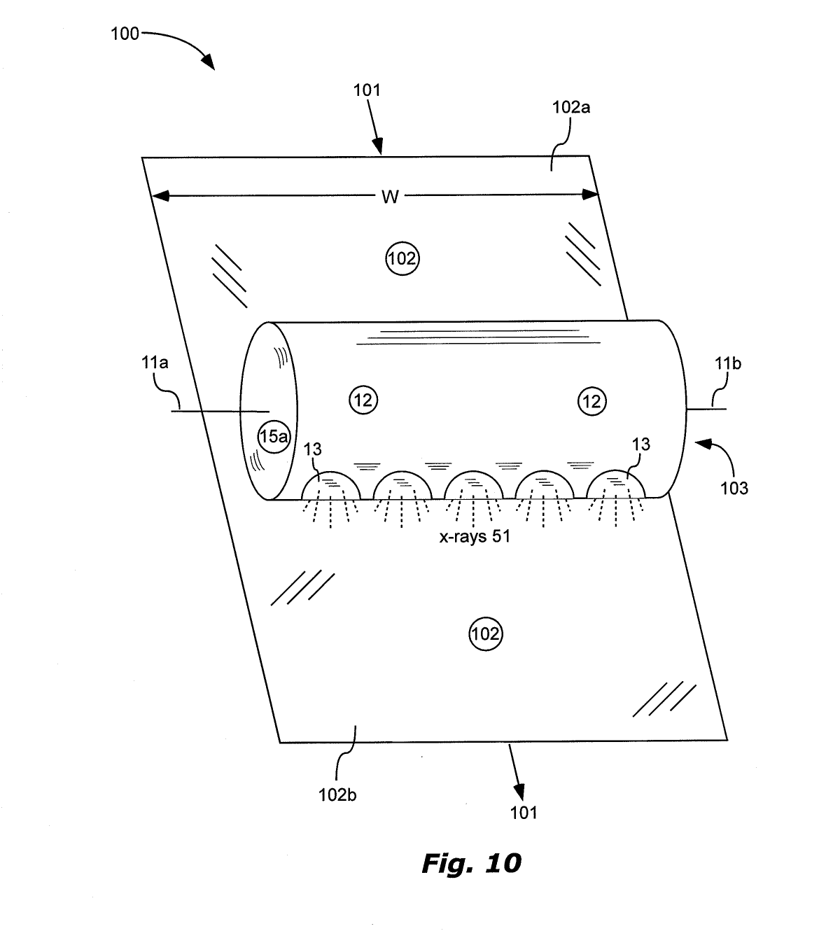

X-ray tubes 10, 40, 50, 60, 70, 80, and 90 of the present design can have a length L that is greater than a diameter D. Length L divided by diameter D can be greater than 1.5 in one aspect, greater than 2.5 in another aspect, or greater than 5 in another aspect. A sufficiently large diameter D may be needed for proper x-ray tube functioning and a sufficient length L may be needed to provide a long curtain of x-rays 51 to cover the desired material 102 (see FIG. 10).

It can be advantageous to substantially or totally block x-rays 51 from being emitted through the anode 12 but substantially allow x-rays 51 to be emitted through the window(s) 13. The anode 12 can substantially block x-rays 51 in order to prevent undesirable exposure. The anode 12 can have a thickness Thₐ and a material configured to substantially block x-rays 51 from passing therethrough. A common use of this “curtain x-ray tube” can be for emission of soft x-rays 51. Thus, the anode 12 can have a thickness Thₐ and a material configured to substantially block soft x-rays from passing therethrough and the window 13 can thus have a thickness Th_{w} and a material configured to allow soft x-rays 51 to pass therethrough with minimal attenuation.

Materials with a high density and/or higher atomic number can be more effective at blocking x-rays 51. Choice of material type and thickness Thₐ can depend on whether other surrounding materials also assist in blocking x-rays 51, the proximity of human users or processes that might be adversely affected, and the energy of x-rays 51 emitted. The anode 12 can block, or prevent transmission of, at least 99% of impinging x-rays 51 in one aspect, at least 99.9% of impinging x-rays 51 in another aspect, or at least 99.99% of impinging x-rays 51 in another aspect. One example for anode 12 material is aluminum. Aluminum may be selected due to its structural strength, corrosion resistance, light weight, and low cost. Although aluminum has a relatively low atomic number (Z=13), its thickness Thₐ can be designed to substantially attenuate soft x-rays 51.

A circumference of the enclosure 15 can consist only of anode 12 or window 13 along an entire length L of the enclosure 15. The user may decide how much of the length L of the enclosure 15 is anode 12 and how much is window 13 based on factors such as the area of desired x-ray 51 coverage, desired x-ray blocking, desired structural strength of the enclosure 15, manufacturability, and cost. For example, at least 50%, at least 60%, at least 70%, or at least 80% of a circumference of the enclosure 15 can be anode 12 along the length L of the enclosure 15. Less than 50%, less than 40%, less than 30%, or less than 20% of a circumference of the enclosure 15 can be window 13 along the length L of the enclosure 15. The window 13 surface area portion of the anode 12 can be various percentages, such as for example 5% to 20%, 5% to 30%, 5% to 40%, or 5% to 50%.

The x-ray tubes described herein can include at least two individual x-ray windows 13 separated by an annular portion of the anode 12. The x-ray tubes can include at least three individual x-ray windows 13. The windows 13 can be disposed on one side of the enclosure 15. The windows 13 can extend in a line 17, or a substantially linear array, along a length L of the enclosure 15 from one end 15a of the enclosure 15 to an opposite end 15b. Shown in FIG. 2 is an x-ray tube 10 with five windows 13, each separated from an adjacent window 13 by an annular portion of the anode 12. All x-ray windows 13 shown in FIG. 2 are disposed on one side of the enclosure 15 and in a line 17 extending from one end 15a of the enclosure 15 to an opposite end 15b.

As shown in FIGS. 2 and 6, the x-ray tubes 10 and 60 can include a tension spring 14 attached to the filament 11 for keeping the filament 11 taut as the filament 11 expands and contracts due to temperature changes. As shown in FIG. 2, the spring 14 can be attached at or near one end 11b of the filament 11. As shown in FIG. 6, the spring 14 can be attached at or near a mid-point or U-bend 11c of the filament 11.

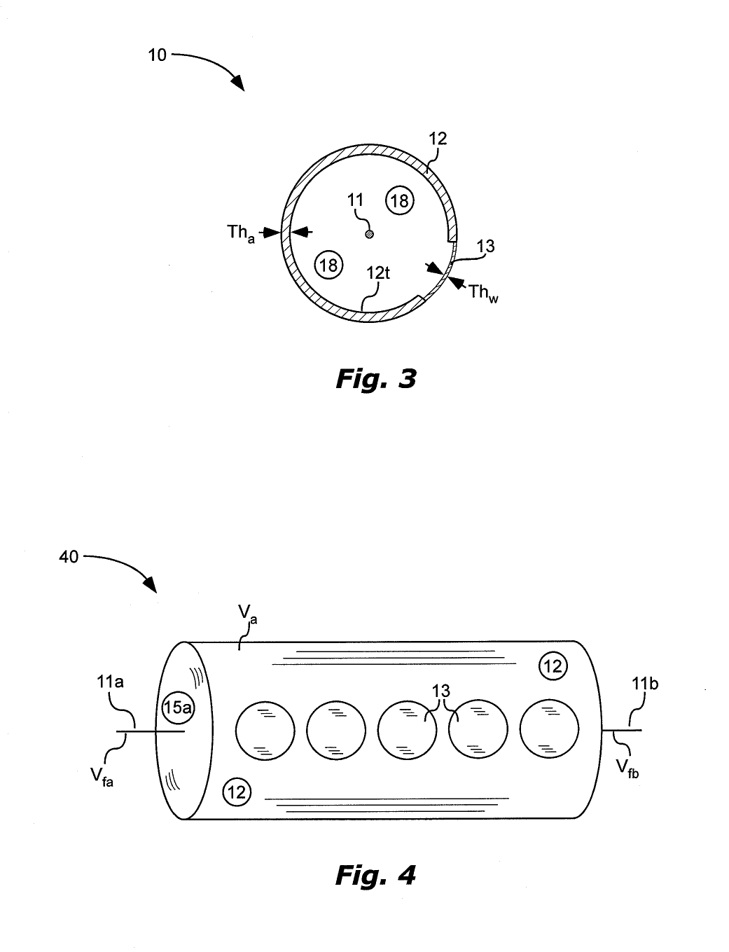

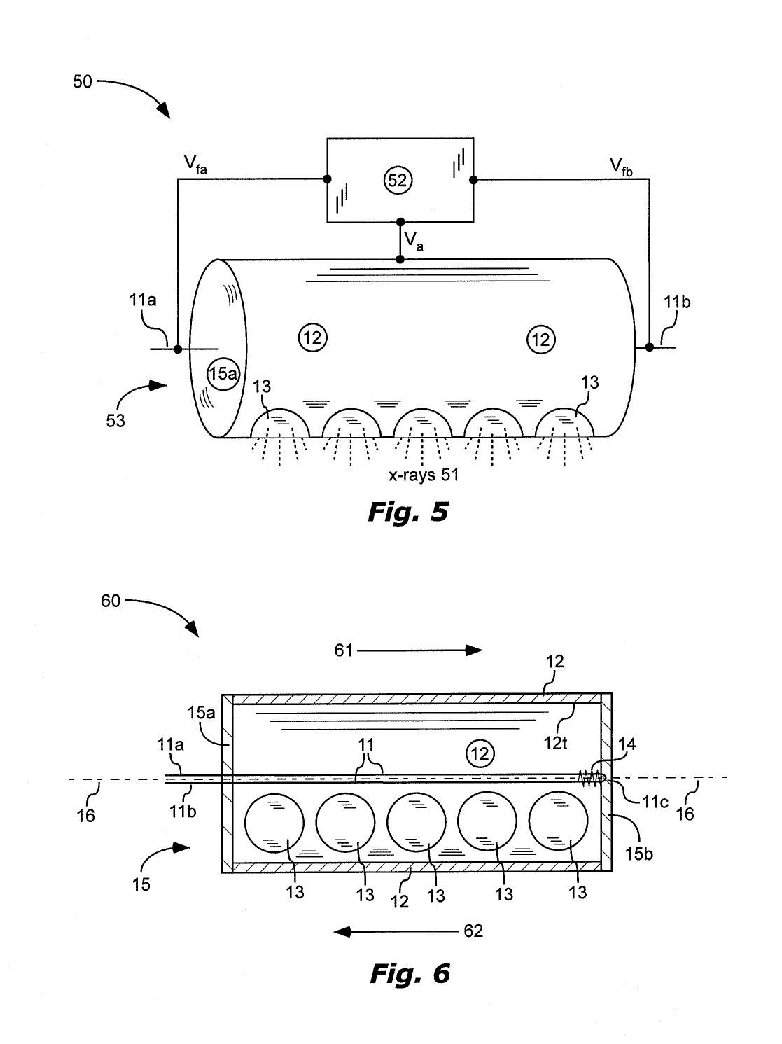

As shown in FIGS. 4-5, the filament 11 can have one voltage V_{fa} attached to one end 11a and a different voltage V_{fb} attached to an opposite end 11b. The voltage differential V_{fa}−V_{fb} between the two ends 11a-b can be constant for a direct current or can vary for alternating current. The electrical current can heat the filament 11. There can be another voltage Vₐ attached to the anode 11, which can be ground. The anode voltage Vₐ can be positive relative to the voltages V_{a-b} at the filament 11. Typically there is a small voltage difference V_{fa}−V_{fb} between the two ends 11a-b of the filament 11, but a very large bias voltage (Vₐ−V_{fa} or Vₐ−V_{fb}) between either end 11a-b of the filament 11 and the anode 12. Due to a high temperature of the filament 11 and the large bias voltage (Va−Vfa or Va−Vfb), electrons can be emitted from the filament 11 towards the anode 12. In one embodiment, the filament 11, when heated by electrical current passing therethrough, can emit electrons along substantially its entire length L from one end of the enclosure 15a to an opposite end of the enclosure 15b.

As shown on x-ray source 50 in FIG. 5, a power supply 52 can be electrically connected to each end 11a-b of the filament 11 and to the anode 12. The power supply 52 can provide a bias voltage (Vₐ−V_{fa} or Vₐ−V_{fb}) between the anode 12 and the filament 11 and can provide a voltage (V_{fa}−V_{fb}) across the filament 11. In one embodiment, the bias voltage (Vₐ−V_{fa} or Vₐ−V_{fb}) and the target material 12t can be configured for production of soft x-rays 51 in the target material 12t. A lower bias voltage (Vₐ−V_{fa} or Vₐ−V_{fb}) may be selected for production of soft x-rays 51 and a higher bias voltage may be selected for production of higher energy x-rays 51.

As shown in FIG. 6, both ends 11a-b of the filament 11 can be at one end 15a of the enclosure 15. The filament 11 can extend in one direction 61 along a length L of the enclosure 15, then can bend back in an opposite direction 62. As shown in FIG. 2, the filament 11 can make a single pass through the enclosure 15 with one filament end 11a configured to be connected to a power supply 52 at one end 15a of the enclosure 15 and an opposite filament end 11b configured to be connected to the power supply 52 at an opposite end 15b of the enclosure 15. Whether to select the multiple pass design of FIG. 6 or the single pass design of FIG. 2 depends on factors such as manufacturability, convenience in attaching connections from the power supply 52, and desired quantity of filament-emitted electron-flux.

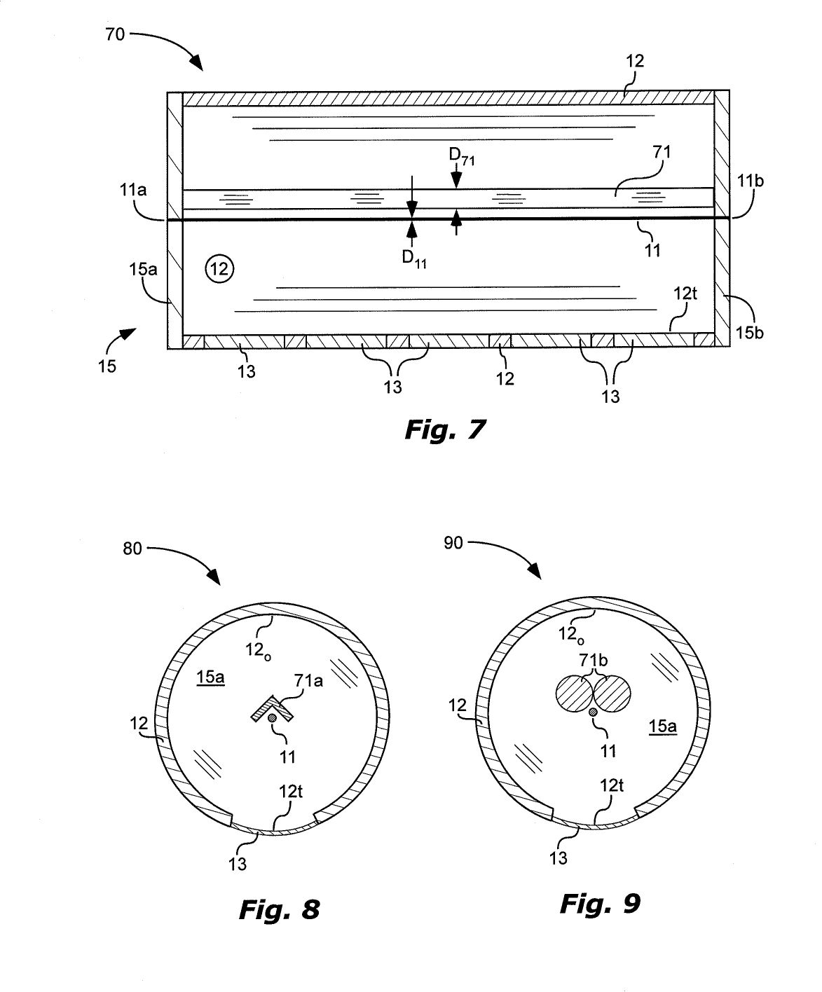

As shown in FIGS. 7-9, the x-ray tubes 70, 80, and 90 can further comprise an electrically-conductive, elongated focusing-structure 71 extending in parallel with the filament 11 from one end 15a of the enclosure 15 to an opposite end 15b. Target material 12t can be disposed solely on the window 13 or on the window 13 and on the anode 12.

Use of a focusing-structure 71 can allow more efficient use of electrical current as most or substantially all electrons from the filament 11 can be directed to the window 13. Thus, this design can require a lower x-ray tube current for the same x-ray flux, thus saving electrical power, as compared to a design without the focusing-structure 71. Use of the entire anode 12 for production of x-rays in a design without the focusing structure 71 can be better for heat transfer, thus reducing the risk of window heat damage. These factors, plus manufacturing cost, can be balanced in each individual design for a determination of whether or not to include a focusing structure 71.

If a focusing-structure 71 is used, it can be disposed in a location to direct electrons from the filament 11 towards the window 13. For example, the filament 11 can be disposed between the focusing-structure 71 and the window 13. The focusing-structure 71 can substantially block electrons from impinging on the anode 12 on an opposite side 12ₒ of the anode 12 from the window.

The focusing-structure 71 can be configured to direct electrons from the filament 11 towards the window 13. For example, the focusing-structure 71 can have a material and profile to shape electric-fields for directing electrons from the filament 11 towards the window 13. The focusing-structure 71 can comprise or consist of a metal. The focusing-structure 71 can be electrically connected to the filament 11 at one location and otherwise electrically isolated from the filament 11. A purpose of an electrical connection between the focusing-structure 71 and the filament 11 is to maintain the focusing-structure 71 at approximately the same voltage as the filament 11. A purpose of a single electrical connection is to avoid allowing electrical current to flow through the focusing structure 71 (the focusing structure 71 does not need to be heated by flowing current as does the filament 11).

The focusing structure 71 can be a V-shaped focusing-structure 71a (i.e. have a V-shaped profile) as shown in FIG. 8. The focusing structure 71 can be two electrically-conductive focusing-wires 71b as shown in FIG. 9. The focusing-wires 71b can have a diameter D₇₁ that is larger than a diameter D₁₁ of the filament 11. For example, each of the focusing-wires 71b can have a diameter D₇₁ that is between 10 and 30 times larger than a diameter D₁₁ of the filament 11 in one aspect or between 5 and 50 times larger than a diameter D₁₁ of the filament 11 in another aspect. For example, the focusing-wires 71b can have a diameter of about 0.75 millimeters and the filament 11 can have a diameter of about 0.05 millimeters.

### Methods

There are various uses of an elongated curtain of x-rays 51 emitted from a single x-ray source. For example, an elongated curtain of x-rays 51 may be used to (1) neutralize an electrical charge in a material (e.g. semiconductor), (2) kill microorganisms in a fluid, (3) catalyze a chemical reaction, or (4) affect a polymer such as by causing cross-linking of monomers to form a polymer or by breaking cross-links of a polymer to form monomers. Below are various methods related to these uses.

Shown in FIG. 10 is a drawing illustrating these uses or methods 100. The elongated x-ray tube 103 can be one of the x-ray tube designs 10, 40, 50, 60, 70, 80, or 90 described above. A material 102 can move 101 under the x-ray tube 103 (relative motion due to movement of the x-ray tube 103 or movement of the material 102). The material 102a can initially be untreated by x-rays 51, and thus can have undesirable static charges, can include undesirable microorganisms, or can be raw material awaiting a chemical reaction. After the material 102b passes through a linear curtain of x-rays 51 emitted by the x-ray tube 103, static charges can be removed, microorganisms can be killed, and/or the chemical reaction can begin or complete. These uses can especially benefit from an elongated curtain of x-rays 51 if there is a flowing or moving material 102 with a relatively large width W. Without the curtain tube designs described herein, multiple x-ray tubes of other designs may be needed to adequately cover the width W with x-rays.

A first method, for neutralizing an electrical charge in a material 102, can comprise:

1. providing an elongated x-ray tube 103 capable of emitting x-rays 51 along substantially an entire length L of the tube 103;
2. emitting a substantially uniform linear curtain of x-rays 51 substantially along the length L of the tube 103 while passing the material 102 through the x-rays 51; and
3. neutralizing an electrical charge in or on the material 102 by use of the x-rays 51.

The material 102 in this first method can be a non-conducting material 102 having a static electric charge. The non-conducting material 102 can be a semiconductor. The material 102 in this first method can be a solid or a flowing fluid.

A second method, for killing microorganisms in a material 102, can comprise:

1. providing an elongated x-ray tube 103 capable of emitting x-rays 51 along substantially an entire length L of the tube 103;
2. emitting a substantially uniform linear curtain of x-rays 51 substantially along the length L of the tube 103 while passing the material 102 through the x-rays 51; and
3. killing the microorganisms with the x-rays 51.
The material 102 in this second method can be a fluid, such as for example air in air handling ducts.

A third method, for catalyzing a chemical reaction, can comprise:

1. providing an elongated x-ray tube 103 capable of emitting x-rays 51 along substantially an entire length L of the tube 103;
2. emitting a substantially uniform linear curtain of x-rays 51 substantially along the length L of the tube 103 while passing a material 102 through the x-rays 51; and
3. catalyzing a chemical reaction in the material 102 with the x-rays 51.

A fourth method, for using x-rays 51 to affect a polymer, can comprise:

1. providing an elongated x-ray tube 103 capable of emitting x-rays 51 along substantially an entire length L of the tube 103;
2. emitting a substantially uniform linear curtain of x-rays 51 along the length L of the tube 103 while passing a material 102 through the x-rays 51, the material 102 is a polymer or individual monomers; and
3. causing cross-linking of monomers to form a polymer, or breaking links of a polymer to form monomers, by use of the x-rays 51.

What is claimed is:

1. An x-ray tube comprising:
a. an elongated, tubular, evacuated enclosure including an electrically conductive anode and a solid x-ray window;
b. an elongated, linear filament disposed in the enclosure and extending along a longitudinal axis of the enclosure, from one end of the enclosure to an opposite end of the enclosure, and configured to emit electrons;
c. the filament being electrically isolated from the anode;
d. an elongated annular gap between the filament and the evacuated enclosure;
e. a target material disposed on an inner surface of the anode, an inner surface of the window, or both;
f. the target material configured to emit x-rays in response to impinging electrons from the filament; and
g. the window configured to substantially allow the x-rays to pass therethrough.

2. The x-ray tube of claim 1, further comprising:
a. an electrically-conductive, elongated focusing-structure extending in parallel with the filament from one end of the enclosure to an opposite end of the enclosure; and
b. the focusing-structure disposed in a location and configured to direct electrons from the filament towards the window.

3. The x-ray tube of claim 2, wherein:
a. the filament is disposed between the focusing-structure and the window;
b. the focusing-structure is capable of substantially blocking electrons from impinging on the anode on an opposite side of the anode from the window.

4. The x-ray tube of claim 2, wherein:
a. the target material is disposed on the window; and
b. non-window portions of the enclosure are substantially free of the target material.

5. The x-ray tube of claim 1, wherein the anode has a thickness and a material configured to substantially block soft x-rays from passing therethrough and the window has a thickness and a material configured to allow soft x-rays to pass therethrough with minimal attenuation.

6. The x-ray tube of claim 1, wherein the window consists of materials having an atomic number less than 17 and the anode including the target material comprises at least one material having an atomic number greater than 46.

7. The x-ray tube of claim 1, wherein a circumference of the enclosure consists of the anode or the anode and the window along an entire length of the enclosure.

8. The x-ray tube of claim 1, wherein at least 60% of a circumference of the enclosure is anode along an entire length of the enclosure.

9. The x-ray tube of claim 1, wherein the x-ray window includes at least two individual x-ray windows separated by an annular portion of the anode.

10. The x-ray tube of claim 1, wherein the window comprises a linear array of windows extending along a length of the enclosure.

11. The x-ray tube of claim 1, further comprising a tension spring attached to the filament for keeping the filament taut as the filament expands and contracts due to temperature changes.

12. The x-ray tube of claim 1, wherein substantially all of an inner surface of the anode is covered with target material.

13. The x-ray tube of claim 1, wherein both ends of the filament are at one end of the enclosure and the filament extends in one direction along a length of the enclosure, then bends back in an opposite direction.

14. The x-ray tube of claim 1, wherein:
a. the filament makes a single pass through the enclosure;
b. one filament end is configured to be connected to a power supply at one end of the enclosure; and
c. an opposite filament end is configured to be connected to the power supply at an opposite end of the enclosure.

15. The x-ray tube of claim 1, wherein the enclosure and the filament have a length greater than 0.4 m and the x-ray tube is configured to provide an x-ray flux substantially along this entire length.

16. The x-ray tube of claim 1, wherein a length of the enclosure divided by a diameter of the enclosure is greater than 2.5.

17. An x-ray tube comprising:
a. an elongated, tubular, evacuated enclosure including an electrically conductive anode, the anode having a thickness and a material configured to substantially block soft x-rays from passing therethrough;
b. a solid x-ray window formed in the enclosure, the window having a thickness and a material configured to allow soft x-rays to pass therethrough with minimal attenuation;
c. a target material disposed on the window and configured to emit x-rays in response to impinging electrons;
d. an elongated, linear filament disposed in the enclosure and extending along a longitudinal axis of the enclosure from one end of the enclosure to an opposite end of the enclosure;
e. the filament configured to emit electrons;
f. the filament being electrically isolated from the anode;
g. an elongated annular gap between the filament and the evacuated enclosure;
h. two electrically-conductive focusing-wires extending in parallel with the filament from one end of the enclosure to an opposite end of the enclosure;
i. the filament being disposed between the focusing-wires and the window; and
j. the focusing-wires being capable of directing electrons from the filament towards the window and substantially blocking electrons from impinging on the enclosure on an opposite side of the enclosure from the window.

18. The x-ray tube of claim 17, further comprising a tension spring attached to the filament for keeping the filament taut as the filament expands and contracts due to temperature changes.

19. A method of neutralizing an electrical charge in a material, the method comprising:
a. providing an elongated x-ray tube capable of emitting x-rays along substantially an entire length of the tube;
b. emitting a substantially uniform linear curtain of x-rays substantially along the length of the tube while passing the material through the x-rays; and
c. neutralizing an electrical charge in or on the material by use of the x-rays.

20. The method of claim 19, wherein the material is a non conducting material having a static electric charge.
